(19) United States
(12) Patent Application Publication
(10) Pub. No.: US 2006/0034318 A1
(43) Pub. Date: Feb. 16, 2006

(54) Method and apparatus for waking up client devices

(75) Inventors: Lilian Sylvia Fernandes, Austin, TX (US); Vinit Jain, Austin, TX (US); Venkat Venkatsubra, Austin, TX (US)

Correspondence Address: IBM CORPORATION (WMA);C/O WILLIAMS, MORGAN & AMERSON, P.C., 10333 RICHMOND, SUITE 1100, HOUSTON, TX, 77042, US

(73) Assignee: INTERNATIONAL BUSINESS MACHINES CORPORATION, ARMONK, NY (US)

(21) Appl. No.: 10/897,337

(22) Filed: Jul. 22, 2004

(51) Int. Cl. H04L 12/66

(52) U.S. Cl. 370/463

(57) ABSTRACT

The present invention provides a method and apparatus for waking up client devices. A method comprising determining a first network address associated with a client device and a second network address associated with the client device and transmitting at least a portion of the first network address and the second network address to a remote device while the client device is in sleep mode.

### BACKGROUND OF THE INVENTION

1. Field of the Invention

The invention generally relates to network communications, and, in particular, to awakening client devices located in a different subnetwork from a host device.

2. Description of the Related Art

In network systems, remote wake-up abilities are often provided for clients. This type of feature allows a client to be turned on (or awakened) through the network. With this feature, a system administrator or other user may wake up a sleeping client by sending a network packet. For example, with a network adapter, such as an Ethernet controller, the adapter is modified to listen for a special wake-up packet on a local area network (LAN) even when the client in which the network adapter is located is asleep (i.e., in power conservation mode). Upon receiving the wake-up packet, the network adapter checks the packet content to ensure that the packet is destined for this particular client. If the packet is destined for the client, the adapter wakes up the sleeping client.

The “wake-up” feature may be used in a large network, where, for example, the administrator's computer may be located on a different subnet from the clients that are being managed by the administrator. In such a case, the “wake-up” packet may be forwarded from the administrator's computer via one or more intermediate network routers to the client that is located on a different subnet from the administrator's computer. However, in instances where the client is located on a different subnet from the transmitting machine, the “wake-up” packet cannot be unicasted to the target client for reasons described next. When a “wake-up” packet arrives at the router of the destination subnet, the router attempts to resolve the medium access control (MAC) address for the target client by sending an address resolution protocol (ARP) request to the target client. However, because the target client is asleep, it will not respond to the ARP request. Thus, a “wake-up” packet cannot be unicasted where the client is located on a different subnet from the transmitting machine.

The above shortcoming is presently solved in the current version of Internet Protocol version 4 (IPv4) by sending the “wake-up” packet via a subnet-directed broadcast to the client that is to be woken up. When the “wake-up” packet reaches the router at the target client's subnet, the router forwards this subnet-directed broadcast packet onto the final subnet where the packet is picked up by each network controller on that subnet.

Transmitting the “wake-up” packet as a subnet-directed broadcast, however, has several drawbacks. First, some routers may not forward the broadcast packets. Thus, the target client may never receive the “wake-up” packet. Second, even if the router broadcasts the “wake-up” packet, every network adapter on the subnet receives, and subsequently processes, the packet. Thus, even the machines that were not the intended recipient may expend valuable resources to process the received packet only to determine that the packet is intended for another machine on the subnet. As such, subnet-directed broadcasts of “wake-up” packets can be inefficient.

The present invention is directed to addressing, or at least reducing, the effects of, one or more of the problems set forth above.

### SUMMARY OF THE INVENTION

In one aspect of the instant invention, a method is provided for waking up client devices. A method comprising determining a first network address associated with a client device and a second network address associated with the client device and transmitting at least a portion of the first network address and the second network address to a remote device while the client device is in sleep mode.

In another aspect of the instant invention, an apparatus is provided for waking up client devices. An apparatus comprising a storage unit communicatively coupled to a control unit. The storage unit is adapted to store a first network address associated with a client device and a second network address associated with the client device. The control unit is adapted to access the first network address and the second network address and transmit information representative of the first network address and the second address to a remote device at a user-defined time interval at least while the client device is in sleep mode.

In yet another aspect of the instant invention, an article comprising one or more machine-readable storage media containing instructions is provided for waking up client devices. The instructions, when executed, enable a processor to determine a first network address associated with a client device and a second network address associated with the client device, defining a time interval at which to transmit the first network address and the second network address to a remote device, and transmit at least a portion of the first network address and the second network address to a remote device at the defined time interval at least during a portion of a period the client device is in sleep mode.

### BRIEF DESCRIPTION OF THE DRAWINGS

The invention may be understood by reference to the following description taken in conjunction with the accompanying drawings, in which like reference numerals identify like elements.

FIG. 1 is a block diagram of an embodiment of a communications system including an address update (AU) module capable of updating an address table in a router and a wake-up module capable of awakening a client device based on receiving a “wake-up” packet, in accordance with the present invention.

FIGS. 2A-2B, respectively, illustrate a flow diagram of one aspect of the AU module and wake-up module of FIG. 1 that may be implemented in the communications system of FIG. 1, in accordance with one embodiment of the present invention.

FIG. 3 depicts an exemplary “wake-up” packet that may be transmitted in the communications system of FIG. 1, in accordance with one embodiment of the present invention.

FIG. 4 depicts a block diagram of a processor-based system and a network adapter that may be implemented in the communications system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

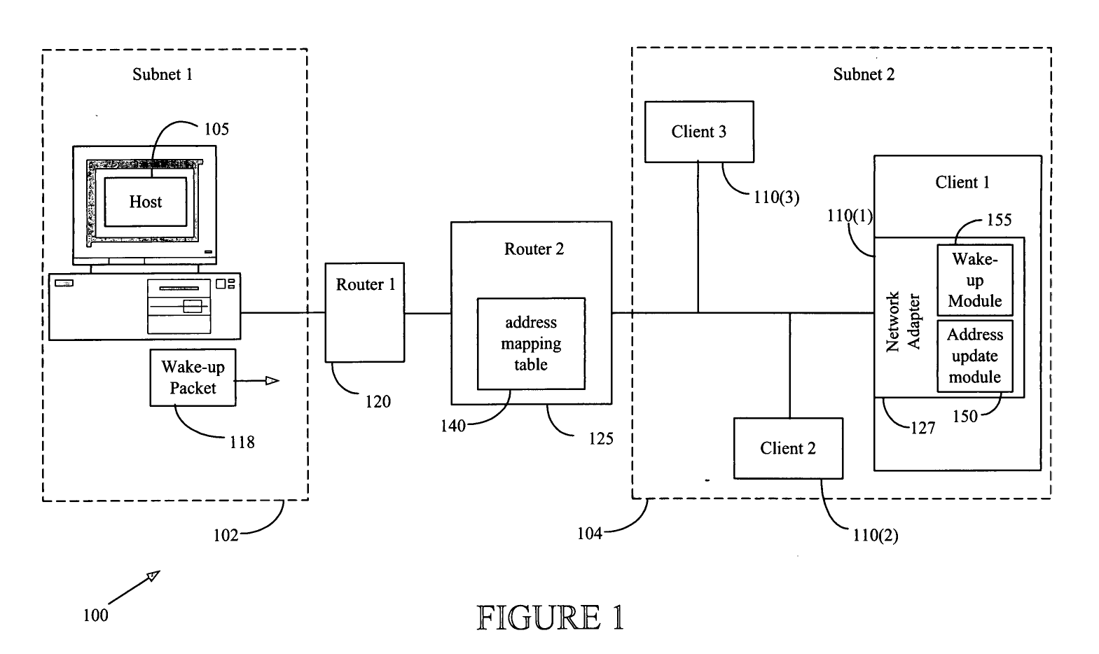

Referring to FIG. 1, a communications system 100 is illustrated in accordance with one embodiment of the present invention. The communications system 100 includes a first subnet (short for subnetwork) 102 and a second subnet 104, both of which may be part of a larger network. The term “subnet,” as utilized herein, refers to an identifiably separate part of a larger network. Thus, a “sub-net” may refer to at least a portion of one or more communications networks, channels, links, or paths, and systems or devices (such as routers) used to route data over networks, channels, links, or paths. For illustrative purposes, only two subnets 102, 104 are shown, although it should be appreciated that in alternative embodiments, any desirable number of subnets may be configured.

In the illustrated embodiment, a host device 105 is associated with the first subnet 102, and a plurality of client devices 110(1-3) are associated with the second subnet 104. It should be appreciated that the arrangement of the communications system 100 of FIG. 1 is exemplary in nature and that, in alternative embodiments, the subnets 102, 104 may include any number of devices 105, 110. The host device 105 and the client 110 may be any suitable type of processor-based device, such as a desktop computer, laptop computer, mainframes, portable devices, or other devices including a processor.

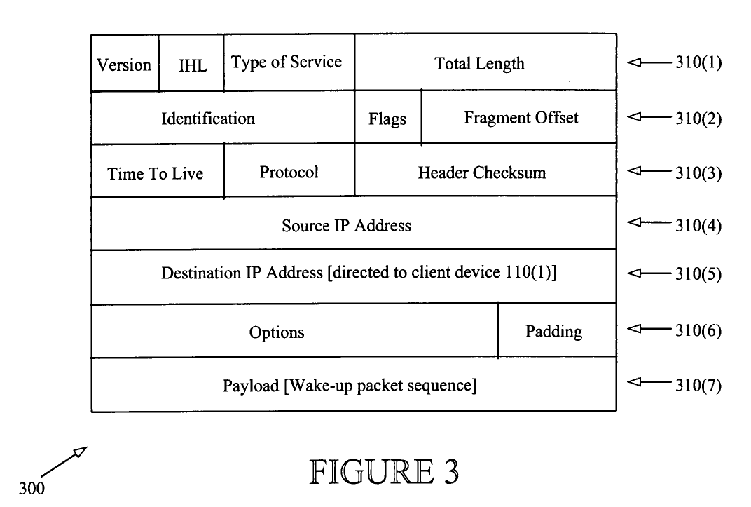

As described in greater detail below, in accordance with one embodiment of the present invention, the host device 105 is able to transmit a “wake-up” packet 118 directed to a particular client device 110 located in a different subnet to awaken that client device 110. That is, instead of relying on a subnet-directed broadcast to awaken a client device 110 situated in a different subnet, the host device 105 is capable of transmitting the “wake-up” packet 118 directed to the particular client device 110 via a unicast transmission. A “wake-up” packet 118 may be a data packet that contains an identifiable (or unique) sequence of bits in the payload field of an IP data packet that enables the receiving network adapter to identify the packet as a “wake-up” packet. An exemplary “wake-up” packet is shown in FIG. 3, discussed later. For the purposes of this discussion, a device that initiates the “wake-up” request is referred to as the “host device,” and the device being awakened is referred to as the “client” device.

In the illustrated embodiment of FIG. 1, the communications system 100 includes a first router 120 associated with the first subnet 102, and a second router 125 associated with the second subnet 104. The host device 105 and the client devices 110(1-3) can communicate with each other via the routers 120, 125. Each device 105, 110 may include a network adapter 127 for interfacing with other components or devices that are coupled to the network in the communications system 100.

The various devices 105, 110, 120, 125 of the communications system 100 in FIG. 1 may communicate with each other using any one of a variety of network protocols, including the Internet Protocol/Transport Control Protocol (TCP/IP). One version of IP (IPv4) is described in Request for Comments (RFC) 791, entitled “Internet Protocol,” dated September 1981, and a version of TCP is described in RFC 793, entitled “Transmission Control Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998.

The routers 120, 125, in the illustrated embodiment, utilize Address Resolution Protocol (ARP) for mapping an Internet Protocol address (IP address) to a physical machine address that is recognized in a network. For example, in IP Version 4, an address is 32 bits long, while in an Ethernet network, the addresses for attached devices (e.g., 105, 110) are 48 bits long. The physical machine address is also known as a Media Access Control (or MAC address). In the illustrated embodiment, the second router 125 utilizes an address mapping table 140 for maintaining a correlation between a network-level address (e.g., Internet Protocol) and a link-level address (e.g., MAC address). In other embodiments, the address mapping table 140 (sometimes also referred to as the “mapping table” in this discussion) may provide a correlation between any variety of protocols or different levels of protocols, depending on the implementation goals. In the context of IPv4, the ARP protocol provides rules for making this correlation. In one embodiment, although not shown, the first router 120 may also include a mapping table.

A brief description of the operation of the ARP protocol is described next in the context of the communications system 100 of FIG. 1, although it should be appreciated that other protocols, such as the Neighbor Discovery Protocol (for IPv6) may also be employed in alternative embodiments. The operation of the ARP protocol is provided herein for illustrative purposes only, and thus it should be understood that the described embodiments are not limited to the ARP protocol or any other protocol. Typically, when an incoming packet destined for a machine (e.g., client 110) on a particular network (e.g., subnet 104) arrives at the router (e.g., router 125), the router 125 requests an ARP program (not shown) to find a physical machine or MAC address that matches the IP address. The ARP program looks in the mapping table 140 and, if it finds the address, provides it so that the packet can be converted to the right packet length and format and sent to the machine or device 110. If no entry is found for the IP address, ARP broadcasts a request packet in a special format to all the machines on the subnet 104 to determine if a machine has that IP address associated with it. A device 110 that recognizes the IP address as its own returns a reply so indicating. The router 125 updates the table 140 for future reference and then sends the packet to the MAC address that replied. Once an entry is created in the mapping table 140, that entry may remain in the mapping table 140 for at least some preselected time, where the preselected amount of time may be a programmable feature of the router 125. Older entries may periodically be deleted or may otherwise be replaced by newer entries in the event that the mapping table 140 becomes full. Because protocol details differ for each type of local area network, there are separate ARP Requests for Comments for Ethernet, Asynchronous Transfer Mode, Fiber Distributed-Data Interface, and other local area network types.

In accordance with one embodiment of the present invention, the network adapter 127 of the client device 110 includes an address update (AU) module 150 that, at user-defined time intervals, transmits information representative of its IP address and MAC address to the router 125 while the client device 110 is in sleep mode. Upon receiving the IP/MAC address information of the client device 110, the router 125 updates its mapping table 140 based on the received address information. Once the mapping table 140 includes an entry for the client device 110, the host device 105 is able to transmit the “wake-up” packet 118 directed to that client device 110. In one embodiment, the network adapter 127 may transmit the address information of the client device 110 to the router 125 at least once while the client device 110 is asleep. In an alternative embodiment, the address information may be transmitted periodically (or at some user-defined interval) to the router 125. It may be desirable to periodically (or at least occasionally) transmit the address information to the router 125 in the event the router 125 clears or deletes entries from its mapping table 140 after expiration of some time period, which may be programmable. In the illustrated embodiment of FIG. 1, the network adapter 127 of the client device 110 includes a wake-up module 155 that monitors for wake-up packets 118 directed for the client device 110, and upon detecting such a packet, the wake-up module 155 awakens the sleeping client device 110.

The various modules 150, 155 illustrated in FIG. 1 are implemented in software, although in other implementations these modules may also be implemented in hardware or a combination of hardware and software. In one embodiment, the network adapter 127 of each client device 110(1-3) that supports the “wake-up” feature may include the modules 150, 155.

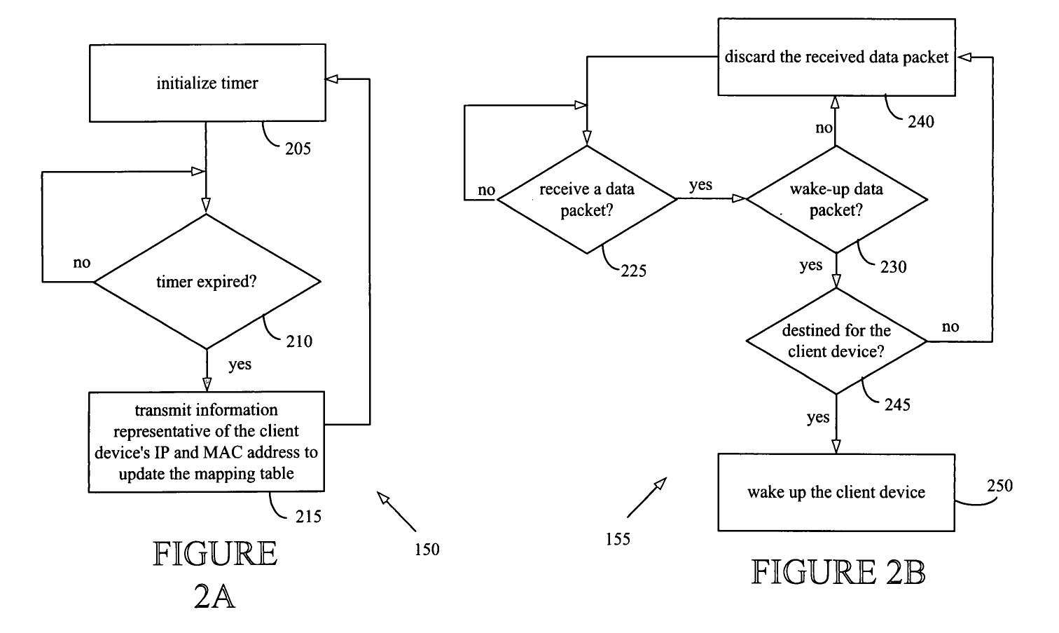

FIGS. 2A-2B depict a flow diagram illustrating at least one operation performed by the address update (AU) module 150 and the wake-up module 155, respectively, in accordance with one embodiment of the present invention. Generally, as noted, the AU module 150 periodically (or at some user-defined intervals) transmits its client device's IP address and MAC address to the router 125, which then updates its mapping table 140 with the received information. The wake-up module 155 monitors for any wake-up packets that are destined for its client device 110, and, upon receiving the wake-up packet, the wake-up module 155 wakes the sleeping client device 110. The AU module 150, in one embodiment, may continue to transmit the address information to the router 125 at the user-defined intervals until the client device 110 wakes up. In the illustrated embodiment, the two modules 150, 155 may each execute substantially currently in the client device 110.

For illustrative purposes, the flow diagrams of FIGS. 2A-B are described in the context of FIG. 1, where the host device 105, which is associated with the first subnet 102, attempts to awaken the first client device 110(1), which is associated with the second subnet 104. For the purposes of this discussion, it is assumed that the first client device 110(1) is in sleep mode (or asleep). The AU module 150 initializes or sets (at 205) a timer to a selected time (e.g., 5 seconds, 30 seconds, etc.) such that, after the expiration of the selected time, the timer generates an interrupt. The expiration of the timer after the “selected time” has passed is hereinafter referred to as a “user-defined time interval.” Thus, a user can define a time interval based on initializing the timer to a selected time. The time interval selected by a user may vary from one implementation to another. In one embodiment, an exemplary user-defined time interval may be ten (10) seconds. In an alternative embodiment, the user-defined time interval may be based on the expiration time of the entries in the mapping table 140 of the router 125. That is, the user-defined time interval may correspond to the “life-span” of an entry in the mapping table 140. Thus, for example, if the aged entries from the mapping table 140 are deleted after twenty (20) seconds, the user-defined time interval may also be substantially twenty (20) seconds, in one embodiment. Of course, in other embodiments, any other suitable time interval may be utilized.

The AU module 150 determines (at 210) if the timer has expired (i.e., the “selected time” has elapsed). In one embodiment, the expiration of the timer may generate an interrupt. This generation of the interrupt may constitute the act of determining (at 210) that the timer has expired. If it is determined (at 210) that the timer has not expired, the AU module 150 continues to check if the timer has expired. In one embodiment, the AU module 150 may wait a predetermined amount of time before rechecking to see if the timer has expired (at 210).

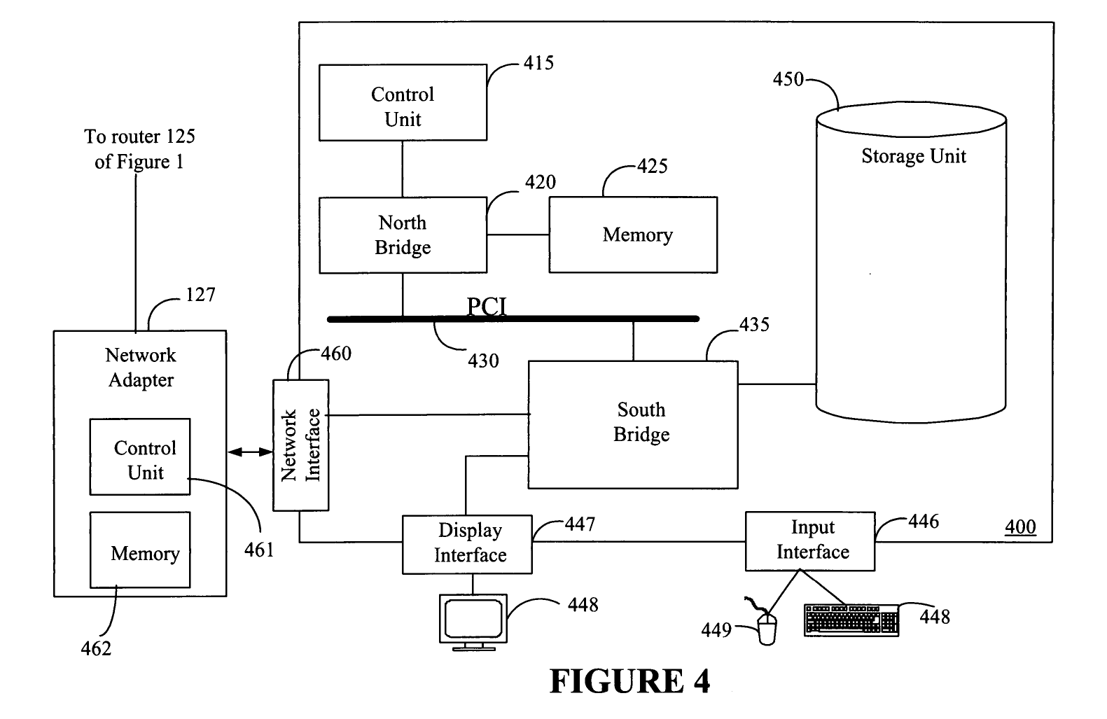

If the AU module 150 determines (at 210) that the timer has expired, then the AU module 150 transmits (at 215) information representative of the IP address and the MAC address of the client device 110(1) to update the mapping table 140 of the router 125. In one embodiment, the information representative of the IP address and the MAC address may comprise transmitting the entire IP and MAC address, or, alternatively, may comprise transmitting at least a portion of the IP and MAC address. The AU module 150 may transmit (at 215) the address information associated with the client device 110(1) to the router 125 in a variety of ways, including in a message or a data packet. The type of “data packet” that may be transmitted to the router 125 can vary from one implementation to another. For example, if the network protocol employed is IPv4, then the packet may be an ARP packet, and if the network protocol employed is IPv6, then the packet may be an NDP (Neighbor Discovery Protocol) packet. The router 125, upon receiving the address information, may update its mapping table 140 with the appropriate IP-MAC address information. In one embodiment, the IP address and the MAC address may be stored in a local memory (shown as element 462 in FIG. 4) of the network adapter 127. The IP/MAC address may be stored in the local memory 462 (see FIG. 4) of the adapter 127, for example, when an IP address is configured for the client device 110(1). The IP address may be assigned to the client device 110(1), for example, when the client device 110(1) is configured to communicate over an Internet Protocol. Alternatively, an IP address may be assigned to the client device 110(1) by another service, such as the Dynamic Host Configuration Protocol (DHCP). It may be advantageous to store the IP/MAC addresses in the local memory 462 so that the network adapter 127 can access these addresses even while the client device 110(1) is asleep.

In one embodiment, the AU module 150 may update (at 215) the mapping table 140 of the router 125 while the client device 110(1) is in sleep mode. That is, the AU module 150 may continue to transmit the IP and MAC address of the client device 110(1) to the router 125 at each scheduled time interval at least during the duration the client device 110(1) is asleep. This transmission of the address information may, in one embodiment, cease once the client device 110(1) is awakened by a “wake-up” packet.

In accordance with one embodiment of the present invention, because the AU module 155 periodically (or at some other user-defined intervals) transmits the address mapping information to the mapping table 140 of the router 125, the host device 105 no longer needs to transmit the “wake-up” packet 118 as a subnet-directed broadcast. Instead, the host device 105 may, in one embodiment, directly address the “wake-up” packet to the client device 110 that is to be woken up. When the “wake-up” packet reaches the router 125 for the destination subnet (e.g., subnet 104 in this case), the router 125 has, because of its updated mapping table 140, access to the appropriate IP-MAP address mapping. As such, the router 125 can forward the “wake-up” packet to the appropriate machine. By removing, or at least reducing, the need to use subnet-directed broadcasts to wake-up client devices 110 located on a different subnet from the host device 105, one or more embodiments of the present invention improve the efficiency of the network because the “wake-up” packet 118 no longer needs to be processed by every client device 110 on that subnet. Moreover, because some routers 125 may not transmit subnet-directed broadcasts, the likelihood of losing “wake-up” messages/packets can also be reduced.

FIG. 2B, as stated, illustrates a flow diagram of one operation of the wake-up module 155, in accordance with one embodiment of the present invention. As noted, for illustrative purposes, it is herein assumed that the client device 110(1) is in sleep mode. While the client device 110(1) is in sleep mode, the wake-up module 155 determines (at 225) if a data packet is received (such as a “wake-up” packet transmitted by the host device 105). If no data packet is received, the module 155 may, in one embodiment, repeatedly check to see if a data packet is received. It should be appreciated that the wake-up module 155 may wait a predetermined amount of time before rechecking (at 225) to see if a data packet is received.

If it is determined (at 225) that a data packet has been received, the wake-up module 155 determines (at 230) if the received data packet is a wake-up packet. The module 155 may identify a “wake-up” packet, in one embodiment, based on the sequence of bits stored in the data field of the packet (i.e., the “wake-up” packet includes a unique sequence of bits in the data packet's payload). If it is determined that the received packet is not a “wake-up” packet, the module 155 discards (at 240) the received data packet. The received data packet may be discarded because the client device 110(1) may not desire to receive packets while it is in the sleep mode.

If the module 155 determines (at 230) that the packet received (at 225) is a “wake-up” packet, the module 155 determines (at 245) if the received “wake-up” packet is directed for the client device 110(1). This may be accomplished by comparing the destination address stored in the destination address field of the “wake-up” packet to the network address of the client device 110(1). If the received “wake-up” packet is not intended for the client device 110(1), the wake-up module 155 discards (at 240) the received “wake-up” packet. A “wake-up” packet may not be intended for the client device 110(1), for example, if it is a subnet-directed broadcast to all the client devices 110(1-3), even though the actual (or intended) destination may be the second client device 110(2) or the third client device 110(3).

If it is determined (at 245) that the received “wake-up” packet is destined for the client device 110(1), the module 155 wakes up (at 250) the client device 110(1). The module 155 may wake up (at 250) the client device 110(1) in any variety of ways, including sending a signal from the network adapter 127 to the motherboard (or processor) of the client device 110(1). The above-described process may be repeated each time the client device 110(1) enters the sleep mode, in one embodiment.

FIG. 3 illustrates an exemplary “wake-up” packet 300 that may be transmitted by the host device 105 to the client device 110(1), where the host device 105 may be located on a different subnet from the client device 110(1). The “wake-up” packet 300 may be one embodiment of the “wake-up” packet 118 shown in the communications system 100 of FIG. 1. Of course, it should be appreciated that the structure and format of the “wake-up” packet 300 may vary from one implementation to another, based in part on the particular communications protocol that is employed. The “wake-up” packet 300 illustrated in FIG. 3 may be employed with the IPv4 protocol.

The “wake-up” packet 300 includes a plurality of sections 310(1-7). The first six sections 310(1-6) are collectively referred to as the “header” section of the packet 300, and the last section 310(7) is commonly referred to as the “payload” section (where the data is stored for the packet 300). The sections 310(1-7) are defined in the IPv4 protocol, and are thus well-known to those skilled the art. As can be seen, the “wake-up” packet 300 illustrated in FIG. 3 may include a unique (or identifiable) sequence in the payload section 310(7) that indicates to the receiving device that the incoming packet is a “wake-up” packet. In accordance with one embodiment of the present invention, and as can be seen in FIG. 3, the destination address section 310(5) of the packet 300 includes a particular destination address directed to the first client device 110(1). This particular destination address is provided by the host device 105, which is able to address the “wake-up” packet to a particular client device 110(1-3) because the AU module 150 updates the mapping table 140 at user-defined intervals such that the IP-MAC address mapping is available to the router 125 at the time the router 125 receives the packet from the host device 105.

Referring now to FIG. 4, a stylized block diagram of a processor-based device 400 that may be implemented in the communications system of FIG. 1 is illustrated, in accordance with one embodiment of the present invention. That is, the processor-based device 400 may represent one embodiment of the host device 105 or the client device 110. The processor-based device 400 comprises a control unit 415, which in one embodiment may be a processor that is capable of interfacing with a north bridge 420. The north bridge 420 provides memory management functions for a memory 425, as well as serves as a bridge to a peripheral component interconnect (PCI) bus 430. In the illustrated embodiment, the processor-based device 400 includes a south bridge 435 coupled to the PCI bus 430.

A storage unit 450 is coupled to the south bridge 435. Although not shown, it should be appreciated that in one embodiment an operating system, such as AIX, Windows®, Disk Operating System®, Unix®, OS/2®, Linux®, MAC OS®, or the like, may be stored on the storage unit 450 and executable by the control unit 415. The storage unit 450 may also include device drivers (not shown) for the various hardware components of the system 400.

In the illustrated embodiment, the processor-based device 400 includes a display interface 447 that is coupled to the south bridge 435. The processor-based device 400 may display information on a display device 448 via the display interface 447. The south bridge 435 of the processor-based device 400 may include a controller (not shown) to allow a user to input information using an input device, such as a keyboard 448 and/or a mouse 449, through an input interface 446.

The south bridge 435 of the system 400, in the illustrated embodiment, is coupled to a network interface 460, which may be adapted to receive, for example, a local area network card. In an alternative embodiment, the network interface 460 may be a Universal Serial Bus interface or an interface for wireless communications. The processor-based device 400 communicates with other devices coupled to the network through the network interface 460. Although not shown, associated with the network interface 460 may be a network protocol stack, with one example being a UDP/IP (User Datagram Protocol/Internet Protocol) stack. UDP is described in RFC 768, entitled “User Datagram Protocol,” dated August 1980. In one embodiment, both inbound and outbound packets may be passed through the network interface 460 and the network protocol stack.

The network interface 460 may interface with the network adapter 127 (see FIG. 1), such as an Ethernet adapter, for example. The network adapter 127 may include a control unit 461 for processing the overall functions of the network adapter 127, and may further include a memory unit 462 communicatively coupled to the control unit 461. The AU module 150 and the wake-up module 155, in one embodiment, may be stored in the memory 461 of the network adapter 127, and may be executable by the control unit 461.

It should be appreciated that the configuration of the processor-based device 400 of FIG. 4 is exemplary in nature and that, in other embodiments the processor-based device 400 may include fewer, additional, or different components without deviating from the spirit and scope of the present invention. For example, in an alternative embodiment, the processor-based device 400 may not include a north bridge 420 or a south bridge 435, or may include only one of the two bridges 420, 435, or may combine the functionality of the two bridges 420, 435. As another example, in one embodiment, the processor-based device 400 may include more than one control unit 415. Similarly, other configurations may be employed consistent with the spirit and scope of the present invention.

The various system layers, routines, or modules may be executable control units (such as control unit 415, 461 (see FIG. 4)). The control unit 415, 461 may include a microprocessor, a microcontroller, a digital signal processor, a processor card (including one or more microprocessors or controllers), or other control or computing devices. The storage devices 450, 462 referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices 450, 462. The instructions when executed by a respective control unit 415, 461 cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
determining a first network address associated with a client device and a second network address associated with the client device; and
transmitting at least a portion of the first network address and the second network address to a remote device while the client device is in sleep mode.

2. The method of claim 1, wherein further comprising:
receiving a network packet to awaken the client device; and
causing the client device to awaken from the sleep mode in response to receiving the network packet.

3. The method of claim 2, wherein receiving the wake-up packet comprises accessing the contents of the network packet to determine if the network packet is destined for the client device and causing the client device to awaken from the sleep mode in response to determining that the network packet is destined for the client device.

4. The method of claim 1, wherein determining the first network address comprises determining a network-level address associated with the client device, and wherein determining the second network address comprises determining a link-level address associated with the client device.

5. The method of claim 4, wherein the remote device is a network router, the network-level address is an Internet Protocol (IP) address, and the link-level address is a Medium Access Control (MAC) address, and wherein transmitting the IP address and the MAC address comprises transmitting the IP address and the MAC address for storage in an address mapping table.

6. The method of claim 5, wherein transmitting the IP address and the MAC address comprises transmitting the IP address and the MAC address in at least one of an ARP packet and a Neighbor Discovery Protocol (NDP) packet to the network router.

7. The method of claim 5, wherein transmitting at least a portion of the first network address and the second network address to the network router comprises transmitting the first network address and the second network address at a user-defined time interval while the client device is asleep, wherein the user-defined interval substantially corresponds to a life span of an entry in the address mapping table of the network router.

8. The method of claim 1, wherein the client device comprises a network adapter, and wherein determining the first network address and the second network address comprises:
storing at least one of the first network address and the second network address in a memory of the network adapter in association with the client device being configured by a user for network communications;
accessing the memory of the network adapter to retrieve at least one of the first network address and the second network address; and
transmitting the accessed network address to the remote device.

9. The method of claim 1, wherein transmitting at least a portion of the first network address and the second network address comprises transmitting the at least portion of the first network address and the second network address to the remote device periodically based on a user-defined time interval while the client device is in the sleep mode.

10. An article comprising one or more machine-readable storage media containing instructions that when executed enable a processor to:
determine a first network address associated with a client device and a second network address associated with the client device;
defining a time interval at which to transmit the first network address and the second network address to a remote device; and
transmit at least a portion of the first network address and the second network address to a remote device at the defined time interval at least during a portion of a period the client device is in sleep mode.

11. The article of claim 10, wherein the instructions when executed enable the processor to:
receive a network packet to awaken the client device; and
cause the client device to awaken from the sleep mode in response to receiving the network packet.

12. A method, comprising:
receiving at least a portion of a first network address and a second network address associated with a client device, where the first network address and the second network address are transmitted at least during an interval the client device is in sleep mode; and
creating an entry in an address mapping table based on receiving the first network address and the second network address.

13. The method of claim 12, wherein the first network address is an IP address and the second network address is a medium access control (MAC) address, further comprising updating the entry in the address mapping table after an expiration of a preselected time interval.

14. The method of claim 13, further comprising:
receiving a packet from a source device for transmission to the client device, the packet comprising at least a portion of one of the first network address and the second network address;
transmitting the packet to the client device based on the contents of the entry of the address mapping table and based on the received portion of at least one of the first network address and the second network address.

15. An apparatus, comprising:
a storage unit adapted to store a first network address associated with a client device and a second network address associated with the client device; and
a control unit communicatively coupled to the storage unit, the control unit adapted to:
access the first network address and the second network address; and
transmit information representative of the first network address and the second network address to a remote device at a user-defined time interval at least while the client device is in sleep mode.

16. The apparatus of claim 15, wherein the control unit is adapted to:
receive a network packet to awaken the client device; and
cause the client device to awaken from the sleep mode in response to receiving the network packet.

17. The apparatus of claim 16, wherein the remote device is a network router, and, wherein the control unit is adapted to transmit information representative of the first network address and the second network address for storage in an address mapping table of the network router.

18. The apparatus of claim 17, wherein the control unit is adapted to transmit information representative of the first network address and the second network address at the user-defined time interval that corresponds to a life span of an entry in the address mapping table of the network router.

19. The apparatus of claim 15, wherein the control unit is adapted to transmit information representative of the first network address and the second network address to the remote device periodically based on the user-defined time interval while the client device is in the sleep mode.

20. The apparatus of claim 15, wherein the first network address is an Internet Protocol (IP) address associated with the client device and the second network address is a Medium Access Control (MAC) address associated with the client device.
